(19) United States
(12) Patent Application Publication
(10) Pub. No.: US 2019/0017456 A1
(43) Pub. Date: Jan. 17, 2019

(54) ENGINE OPERATOR INITIATED SELF-ADJUSTMENT SYSTEM

(71) Applicant: Walbro LLC, Tucson, AZ (US)

(72) Inventors: Martin N. Andersson, Caro, MI (US); Dale P. Kus, Cass City, MI (US); George M. Pattullo, Caro, MI (US)

(21) Appl. No.: 16/070,546

(22) PCT Filed: Jan. 11, 2017
(86) PCT No.: PCT/US2017/012947

§ 371 Date: Jul. 17, 2018

Related U.S. Application Data
(60) Provisional application No. 62/280,343, filed on Jan. 19, 2016.

(51) Int. Cl. F02D 41/14; F02D 41/00; F02D 41/26; G01M 15/05; F02B 63/02

(52) U.S. Cl. CPC F02D 41/1475; F02D 41/0097; F02D 41/1458; F02D 41/1497; F02D 41/08; G01M 15/05; F02B 63/02; F02D 2400/06; F02D 41/26

(57) ABSTRACT

An operator initiated control process for an engine which tests the air-to-fuel ratio of an air-fuel mixture supplied to the engine when it is in stable operation and if need be changes the air-to-fuel ratio to improve engine performance and/or meet engine exhaust emissions requirements.

### REFERENCE TO RELATED APPLICATION

This patent application claims the benefit of the earlier filed U.S. provisional patent application, Ser. No. 62/280,343, filed on Jan. 19, 2016, which is incorporated herein by reference in its entirety.

### TECHNICAL FIELD

The present disclosure relates generally to utility internal combustion engines and more particularly to a fuel control system and process for such engines.

### BACKGROUND

Small or utility internal combustion engines are used to power a variety of various products including lawn and garden products such as chain saws, lawn mowers, edgers, grass and weed trimmers, leaf air blowers and the like. Many of these engines are single cylinder two-cycle or four-cycle spark ignited gasoline powered internal combustion engines having a carburetor or other device supplying a gasoline fuel and air mixture to the combustion chamber of the operating engine. The air-to-fuel ratio of the fuel mixture may be calibrated for a particular engine or a particular product but different engine operating characteristics such as varying loads during use of the product, type of fuel, altitude, condition of the air filter and/or differences among engines and/or components in a production run may adversely affect engine operation and performance. To improve engine performance and operation under a variety of these and other conditions, some engines include a control system and process which throughout essentially every period of engine continuous operation repeatedly and substantially continuously tests and determines whether a proper air-to-fuel ratio of the fuel mixture is being supplied to the engine and, if not, changes the air-to-fuel ratio of the supplied fuel mixture to improve engine operation and performance and often to control exhaust emissions to comply with Governmental regulations.

One such system and method which essentially continuously tests and if need be changes the ratio of air-to-fuel of an air-fuel mixture it delivers to an operating engine is disclosed in U.S. patent application, Ser. No. 14/773,993, filed Sep. 9, 2015, the disclosure of which is incorporated herein by reference in its entirety. In this method, the engine operating speed is sensed and determined, an air-to-fuel ratio of a fuel mixture delivered to the operating engine is changed and preferably enleaned, and a second engine speed is sensed and determined after at least some and preferably near the end of the changed air-to-fuel ratio event. Based at least in part on the difference between the first and second engine speeds, it is determined whether a change in the air-to-fuel ratio of the fuel mixture supplied to the engine is needed or desired and, if so, a change in the air-to-fuel ratio of the fuel mixture delivered to the engine is implemented. Developing such a control system and method which is always trying to automatically sense and adjust the air-to-fuel ratio of the operating engine in the field and essentially continuously during the entire time period of each engine operation can be difficult and requires relatively complex programming in order to essentially eliminate the risk of erroneous automatic self-adjustment events which may be initiated by unforeseen engine operating conditions.

### SUMMARY

An operator starts a process which includes determining whether an engine is operating in a sufficiently stable condition to test and determine whether the air-to-fuel ratio of the air-fuel mixture supplied to the engine should be changed to a new ratio used for at least substantially the remainder of a period of engine continuous operation. The operator may initiate this process by manipulating and cycling the throttle valve of a carburetor or other device supplying the air-fuel mixture to the engine or by actuating an electronic circuit of an external device connected to the engine control module circuit. If the engine operation is sufficiently stable, the process may include in some implementations, steps of determining a first engine speed, changing the air-to-fuel ratio of the fuel mixture supplied to the engine, determining a second engine speed after at least some of the air-to-fuel ratio change event has occurred and preferably at or near the end of such event. Based at least in part on the difference between the first and second engine speeds, it is determined whether a change in the air-to-fuel ratio should be made, and, if so, a new air-to-fuel ratio is determined and supplied to the engine for at least substantially the remainder of a period of engine continuous operation. If the engine operation is not sufficiently stable, during the steps of determining the first engine speed, changing the air-to-fuel ratio and determining the second engine speed, the air-to-fuel ratio for the operating engine is not changed for the remainder of at least a period of engine continuous operation.

### BRIEF DESCRIPTION OF THE DRAWINGS

The following detailed description of preferred embodiments and best mode will be set forth with reference to the accompanying drawings, in which:

FIG. 1 is a perspective view of a weed and grass string trimmer with an engine having a control module at least in part implementing a process of this invention;

FIG. 2 is a schematic view of the engine of FIG. 1 with a carburetor including an air-to-fuel ratio change device;

FIG. 3 is a fragmentary schematic view of a flywheel and magneto component of the engine;

FIG. 4 is a schematic diagram of an engine ignition and air-to-fuel ratio control circuit;

FIG. 5 is a flow chart of a process of testing engine operating stability and air-to-fuel ratio and adjustment;

FIG. 6 is a flow chart of the air-to-fuel ratio testing and adjustment portion of the process;

FIG. 7 is a graph of a representative engine power curve;

FIG. 8 is a flow chart of a first modified form of the process;

FIG. 9 is a flow chart of a second modified form of the process;

FIG. 10 is a schematic diagram of an actuator circuit of a device an operator can use to start the control circuit to carry out the process;

FIG. 11 is a flow chart of a modified form of the process used with the actuator circuit of FIG. 10; and

FIG. 12 is a modification of the actuator circuit of FIG. 10 for use with a personal computer.

### DETAILED DESCRIPTION OF PREFERRED EMBODIMENTS

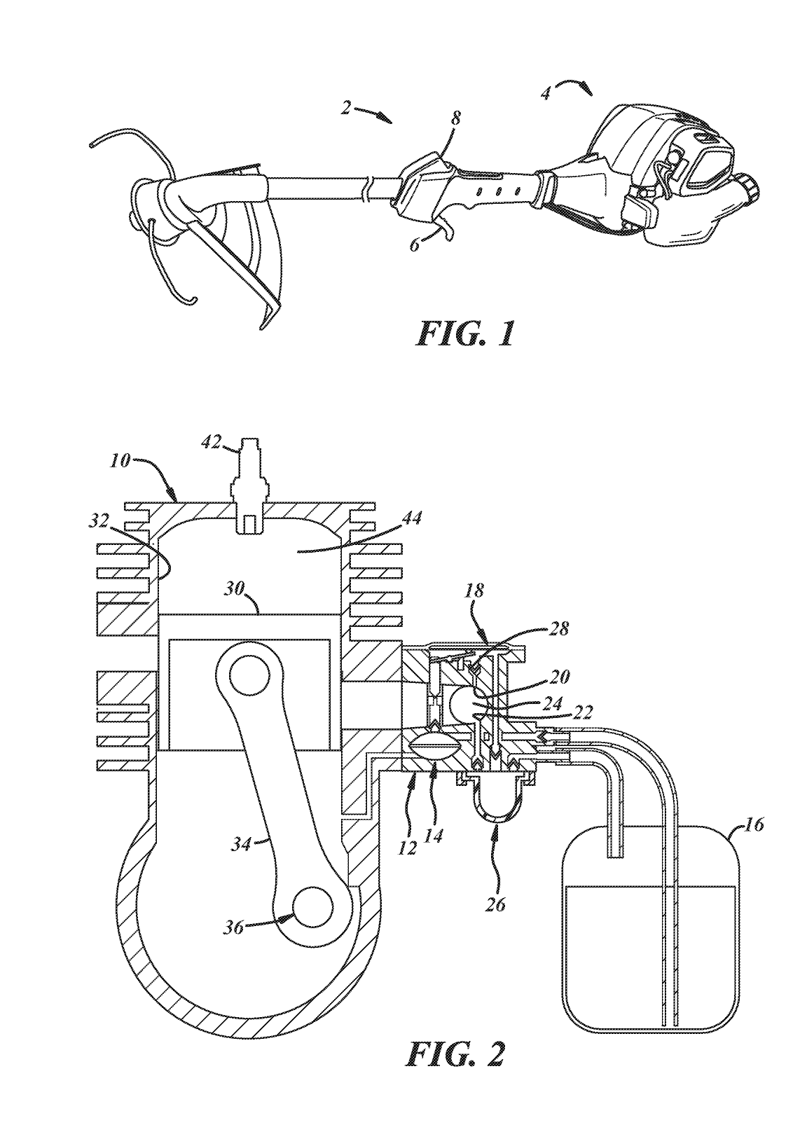

Referring in more detail to the drawings, FIG. 1 illustrates a string trimmer 2 with an engine 4 powering the string trimmer and having a charge-forming device with a throttle valve operably connected to a throttle lever 6. The string trimmer has an engine kill switch 8 electrically connected to an electronic control circuit of the engine. The kill switch and the throttle lever can each be manually actuated and controlled by an operator of the string trimmer.

FIG. 2 illustrates a spark ignited gasoline powered internal combustion engine 4 with a charge forming device that delivers a fuel-and-air mixture to the operating engine. The charge forming device may be a fuel injector, carburetor or another device. The charge forming device is illustrated as a carburetor such as a diaphragm carburetor 12 which is typically used on engines for chain saws, air blowers, grass and weed trimmer products and the like. The carburetor 12 has a diaphragm actuated fuel pump 14 which receives liquid gasoline fuel from a fuel tank 16 and supplies fuel to a diaphragm fuel metering system 18 which supplies fuel through a main nozzle or jet 20 to a fuel-and-air mixing passage 22 communicating with the engine. The carburetor includes a throttle valve 24 movable between idle and wide open throttle positions to control the flow or quantity of the air-fuel mixture supplied to the operating engine. This carburetor typically includes a manually actuated fuel purge and primer assembly 26. The general construction, function and operation of such a diaphragm carburetor is well known in the art and one example of this type of carburetor is disclosed in U.S. Pat. No. 7,467,785, the disclosure of which is incorporated herein by reference in its entirety.

The carburetor 12 also has a mixture control device such as a solenoid valve assembly 28 which is operable to change the quantity of fuel flowing into the mixing passage 22 such as through the main fuel jet 20 to thereby alter or change the air-to-fuel ratio of the fuel mixture supplied by the carburetor to the operating engine as controlled by the throttle valve. The solenoid valve assembly 28 may be normally open and energized to close to change the air-to-fuel ratio to enlean the air-fuel mixture supplied to the operating engine. A suitable solenoid control valve is disclosed in U.S. patent application, Ser. No. 14/896,764, filed Dec. 8, 2015, which is incorporated herein by reference in its entirety.

Typically, the engine 4 is a utility or light duty single cylinder two-stroke or four-stroke spark ignited gasoline powered internal combustion engine. Typically, this engine has a single piston 30 slidably received for reciprocation in a cylinder 32 connected by a tie-rod 34 to a crankshaft 36 attached to a flywheel 38. Typically, this engine has a capacitive discharge ignition (CDI) system for supplying a high voltage ignition pulse to a spark plug 42 for igniting an air-fuel mixture in the engine cylinder combustion chamber 44. This module varies and controls the ignition timing relative to a top dead center position of the piston in response to changing engine operating conditions.

Typically, this engine 10 does not have any battery supplying an electric current to the spark plug or powering the ignition control module which typically includes a microcontroller. This engine is manually cranked for starting with an automatic recoil rope starter.

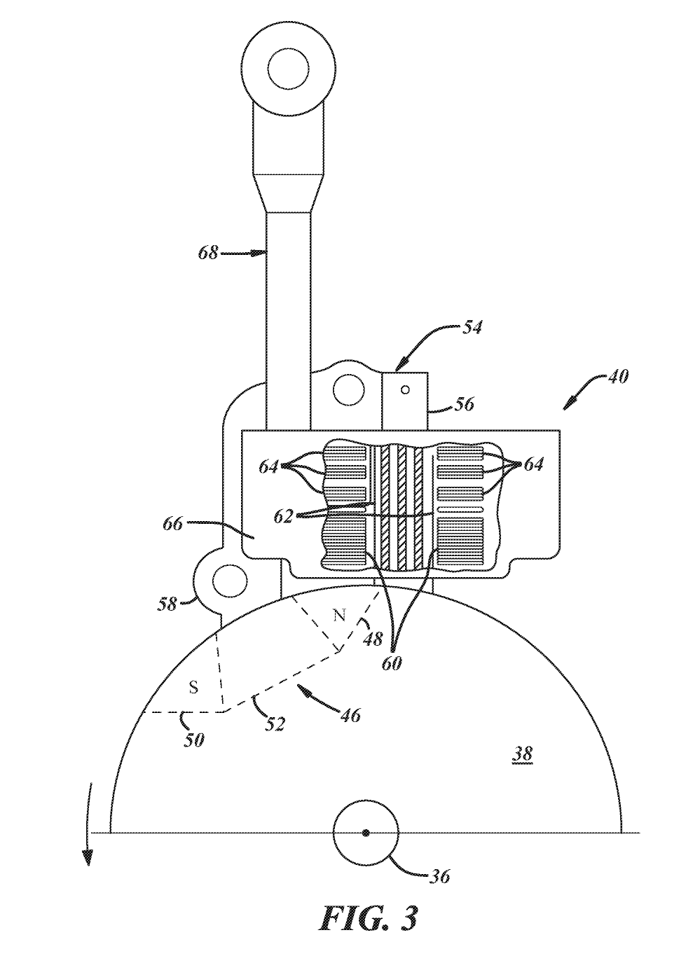

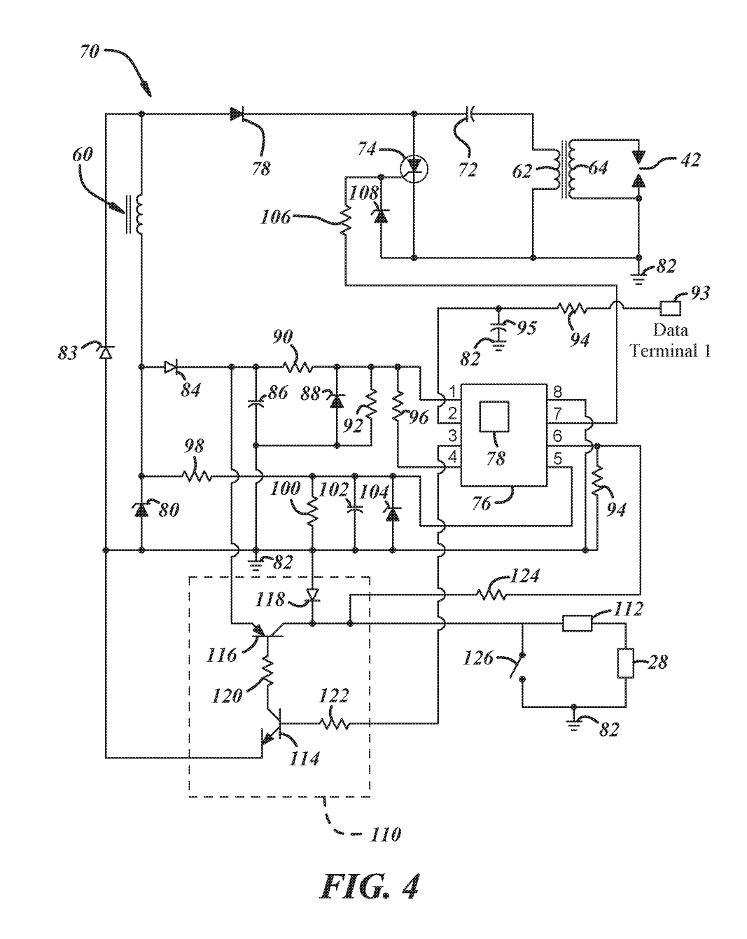

FIGS. 3 and 4 illustrate an exemplary engine ignition and air-to-fuel ratio control system 40 for use with the internal combustion engine. This control system could be constructed according to any one of numerous designs including a magneto and capacitor discharge spark ignition system. This system includes a magnetic section 46 with north and south pole shoes 48 & 50 with a permanent magnet(s) 52 mounted on the flywheel 38 for rotation therewith such that when rotating it induces a magnetic flux in a nearby stator assembly of the control module as the magnetic section passes thereby.

The stator assembly includes a lamstack 54 having a first leg 56 and a second leg 58 (separated from the rotating flywheel by a relatively small measured air gap which may be about 0.3 mm), a charge or power coil winding 60, an ignition transformer primary coil winding 62 and a secondary transformer coil winding 64 which may all be wrapped around a single leg of the lamstack. The lamstack 54 may be a generally U-shaped ferrous armature made from a stack of iron plates and may be in a module housing located on the engine. The ignition primary and secondary coil windings provide a step-up transformer and as is well known by those skilled in the art, the primary winding 62 may have a comparatively few turns of a relatively heavy gauge wire, while the secondary ignition coil winding 64 may have many turns of a relatively finer wire. The ratio of turns between the primary and secondary ignition windings generates a high voltage potential in the secondary winding that is used to fire the spark plug 42 of the engine to provide an electric arc or spark and consequently ignite an air-fuel mixture in the engine combustion chamber 44. The high voltage in the secondary winding is supplied to the spark plug through an insulated electric wire 68 connected to the center electrode of the spark plug covered by an insulating boot.

As shown in FIG. 4, the power coil and the transformer coils are coupled to a control circuit 70 of the control system 40. The term “coupled” broadly encompasses all ways in which two or more electrical components, devices, circuits, etc. can be in electrical communication with one another; this includes, but is not limited to, a direct electrical connection and a connection being an intermediate component, device, circuit, etc. This control circuit 70 includes an energy storage and ignition discharge capacitor 72, an electronic ignition switch 74 preferably in the form of a thyristor, such as a silicon controlled rectifier (SCR), and a microcontroller 76. One end of the power coil 60 is connected through a diode 78 to the ignition capacitor 72 and the other end of the power coil is connected through a diode 80 to the circuit ground 82. The one end of the power coil may also be connected through another diode 83 to the circuit ground. A majority of the energy induced in the power coil 60 is supplied to the capacitor 72 which stores this energy until the microcontroller 76 changes the switch 74 to a conductive state to discharge the capacitor 72 through the primary winding 62 of the transformer which induces in the secondary winding 64 a high voltage potential which is applied to the spark plug 42 to provide a combustion igniting arc or spark. More specifically, when the ignition switch 74 is turned on (in this case, becomes conductive), it provides a discharge path for the energy stored on the capacitor 72. This rapid discharge of the capacitor causes a surge in current through the primary ignition winding 62 which in turn creates a fast rising electromagnetic field in the primary ignition winding which induces a high voltage pulse in the secondary ignition winding 64 which travels to the spark plug 42 to produce an arc or spark. Other sparking techniques, including a flyback technique, may be used instead.

The microcontroller 76 may include a memory 78 which can store a look-up table, algorithm, and/or code to determine and vary the engine ignition timing usually relative to top dead center of the piston 30 in the cylinder 32 for various engine operating speeds and conditions. The microcontroller may also change and control the fuel-to-air ratio of the air-fuel mixture supplied to the operating engine in response to various engine operating speeds and conditions. Various microcontrollers or microprocessors may be used as is known to those skilled in the art. Suitable commercially available microcontrollers include Atmel Model ATtiny series and Microchip Module PIC family. Examples of how microcontrollers can implement ignition timing systems can be found in U.S. Pat. Nos. 7,546,846 and 7,448,358, the disclosures of which are incorporated herein by reference in their entirety. The memory 78 may be a reprogrammable or flash EEPROM (electrically erasable, programmable read-only memory). In other instances, the memory may be external of and coupled to the microcontroller. The memory should be construed broadly to include other types of memory such as RAM (random access memory), ROM (read-only memory), EPROM (erasable, programmable, read-only memory), or any other suitable non-transitory computer readable medium.

As shown in FIG. 4, the microcontroller 76 includes eight pins. To power the microcontroller, the circuit has a diode 84, a capacitor 86, a zener diode 88, and a resistor 90 electrically connected in the circuit to the power coil 60 and to pin 1. Pin 2 is also connected to a data terminal 93 through a resistor 94, and through a capacitor 95 to ground 82 to prevent circuit noise from adversely affecting the microcontroller. Pin 4 is an input pin which does not perform any function in this circuit and is connected through a resistor 96 to pin 1 to avoid any circuit noise adversely affecting the microcontroller performance.

An electronic signal representative of the engine speed and the position of its piston in its combustion chamber usually relative to the top dead center (TDC) position of the piston is provided to pin 5 through a connection to the power coil 60 via resistors 98 and 100, a capacitor 102 and a zener diode 104. The resistor 100, capacitor 102 and zener diode 104 are in parallel and also connected to the circuit ground 82. This signal can be referred to as a speed signal and the microcontroller 76 can use this speed signal to determine engine speed (RPM), the timing of an ignition pulse relative to the piston TDC position (usually from a look-up table), and whether or not and, if so, when to activate the switch 74 to provide an ignition pulse. To control the ignition switch 74, microcontroller pin 7 is connected to the gate of the ignition switch via a resistor 106 (which is in circuit with a zener diode 108 connected to the cathode and ground 82) and transmits from the microcontroller an ignition signal which controls the state of the switch 74. When the ignition signal on pin 7 is low, the ignition switch 74 is non-conductive and the capacitor 72 is allowed to charge. When the ignition signal is high, the ignition switch 74 is conductive and the ignition capacitor 72 discharges through the primary ignition transformer coil 62, thus causing a high voltage ignition pulse to be induced in the secondary ignition coil 64 and applied to the spark plug 42. Thus, the microcontroller 76 governs the discharge capacitor 72 by controlling the conductive state of the SCR or switch 74. Through pin 8, the microcontroller ground is connected to the circuit ground 82.

The microcontroller 76 may also be used to actuate the solenoid control valve 28, although alternatively a separate controller may be used. As shown in FIG. 4, the control circuit 70 may include a solenoid valve driver sub-circuit 110 communicated with pin 3 of the controller and with the solenoid at a node or connector 112. When pin 3 goes high, it turns on the transistor 114 via resistor 122 which resistor 122 limits the current into the base of the transistor 114. When transistor 114 is turned on, current is allowed to flow from capacitor 86 via transistor 116, resistor 120 and via collector-emitter of transistor 114 to ground 82. This base current for transistor 116 will get amplified in the transistor 116 and allow a much higher current to flow from capacitor 86 via transistor 116 through the connector 112 to the solenoid valve 28. A diode 118 is placed in parallel with the solenoid to act as a recirculating diode when the transistor 116 in its off state. Pin 3 of the microcontroller is controlled by pulse with modulation (PWM), usually at a frequency of 4-10 kHz. Therefore, transistor 116 will turn on and off very quickly. A resistor 124 is connected between connector 112 and pin 6, and is used together with resistor 94 to sense when the terminal 112 is connected to ground or not, through a normally open engine kill switch 126 which when closed causes the microcontroller 76 to stop the engine by not providing voltage pulses to the spark plug 42. Pin 3 also provides a short voltage pulse of about 20-100 microseconds which is sensed by pin 6 to determine whether the kill switch 126 is closed. This pulse does not provide enough energy to change the state of the solenoid valve 28.

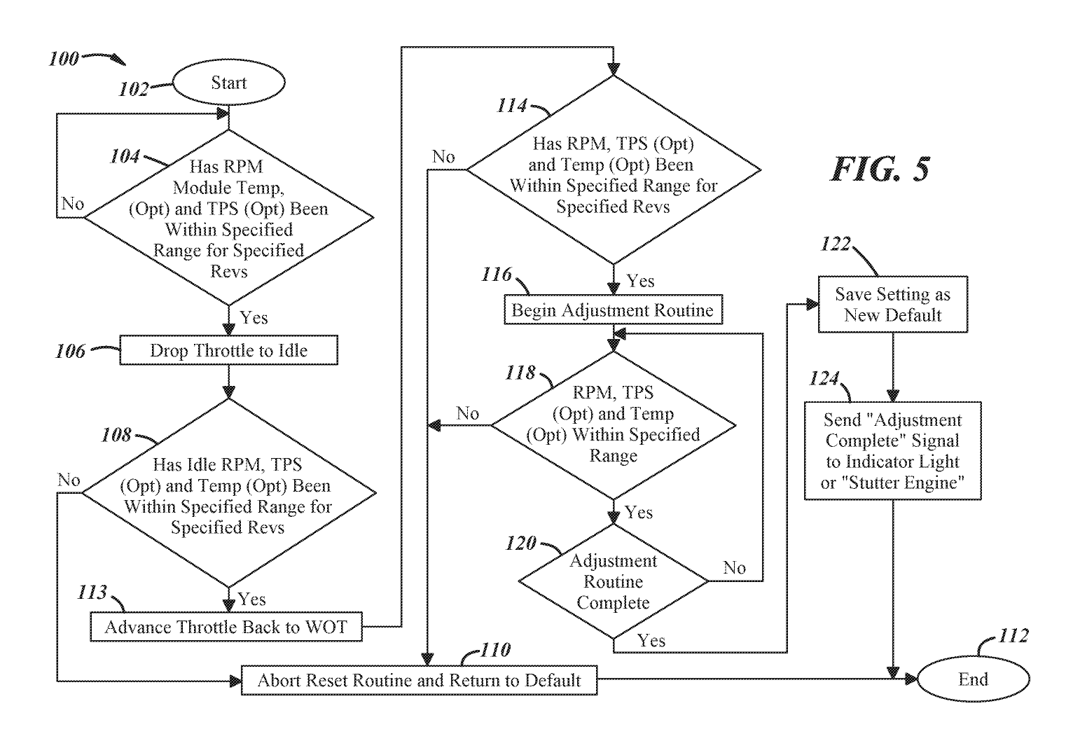

As shown in FIG. 5, implementation of a process 100 can be carried out with the microprocessor 76 and suitable programming or by a separate processor with suitable programming. The engine is started and warmed up using a default air-to-fuel ratio. Upon engine start-up or shortly thereafter, the process 100 is started at 102 and at step 104 it is determined whether the engine is warmed up by determining whether the engine speed (RPM) and optionally the engine or module temperature, and/or throttle valve position have been within the specified range for a specified number of engine crankshaft revolutions. If not, it repeats step 104. If so, then step 106 determines whether the operator has moved or otherwise the throttle valve 24 is in its idle position. If so, it moves to step 108 to determine whether the engine is in a stable idle operating condition by determining if the engine speed (RPM) [and optionally the throttle lever or throttle valve position and/or the engine or module temperature] is within a specified range for a specified number of crankshaft revolutions. If not, it goes to step 110 to abort or stop this process 100 and continues to use the default air-to-fuel ratio of the air-fuel mixture supplied to the engine during steps 104, 108 for the remainder of this period of engine continuous operation and ends the process at 112. If so, at step 112, it determines whether the operator has advanced the throttle lever or valve to the wide open throttle (WOT) position. If so, it advances to step 114. The WOT position can be determined in a variety of ways including a change of state of an electric switch by movement of the throttle lever or the throttle valve to its WOT position or by the processor determining if the engine is operating in a high speed (RPM) range preferably for at least a specified number of revolutions.

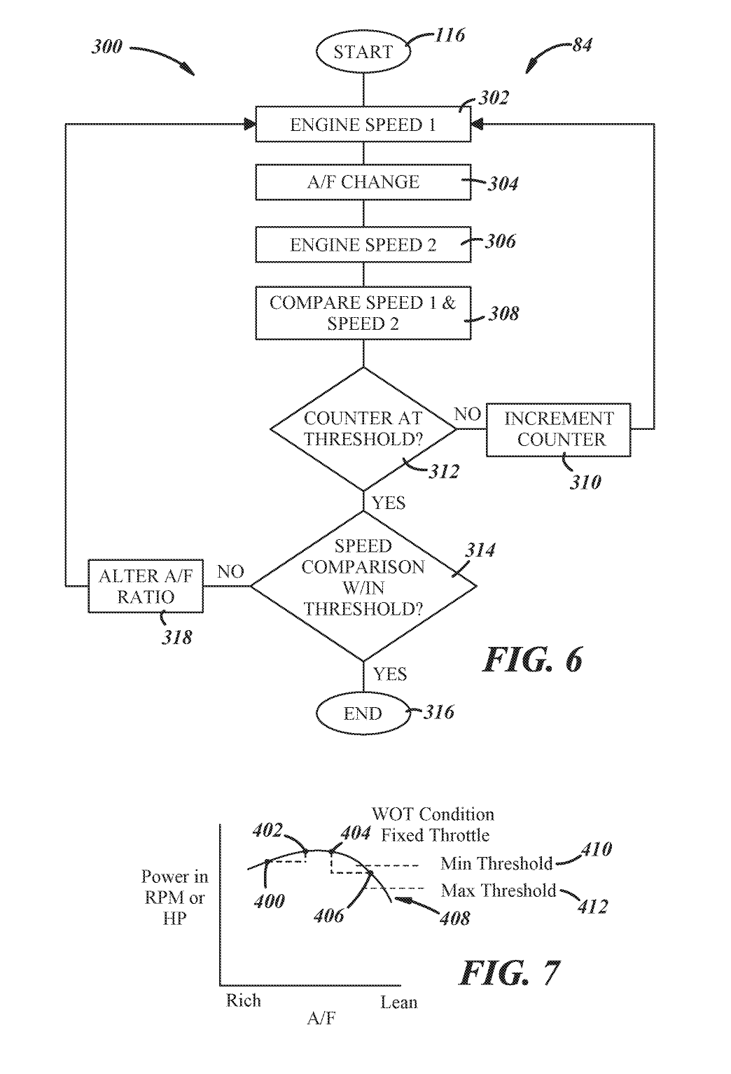

At step 114, the processor again determines whether the engine speed (RPM) and optionally the throttle position and/or temperature is within a specified range for a specified number of engine revolutions. Desirably, in step 114 the engine is operating at a speed range of about 60% to 100% of its speed (RPM) at the WOT position of its throttle valve. If not, it returns to step 110 which aborts the process, uses the default air-to-fuel ratio for the rest of this period of engine continuous operation and ends the process at 112. If so, it advances to step 116 which starts an air-to-fuel ratio testing and adjustment process portion shown at 300 in FIG. 6.

As shown in FIG. 6, if the process portion 300 was started (at step 116), at step 302 the microcontroller 76 determines a first engine speed, at step 304 changes and preferably enleans the air-to-fuel ratio such as by closing the fuel solenoid valve 28 for several engine revolutions, and at step 306 determines a second engine speed after at least some and desirably at or near the end of this changed air-to-fuel ratio event of step 304. At step 308, the first and second engine speed determinations or measurements 302 and 306 are compared. This enleanment can be accomplished in several different ways, including without limitation only partially closing the solenoid valve 28, bleeding air into the fuel flowing into the mixing passage 22, changing the pressure acting on the metering valve assembly 18, increasing air flow through the mixing passage downstream of the fuel jet 20, bleeding air into the mixing passage downstream of the fuel jet, and the like.

To improve the accuracy of this process portion 300, desirably several of these engine speed tests may be performed with a counter incremented at 310 after each speed test, and the counter compared to a threshold at step 312 to determine if a desired number of engine speed tests have been performed. If not, the routine returns to steps 302 through 308 for another speed test. If a desired number of speed tests have been performed, at step 314 the process analyzes the difference(s) between engine speeds 1 & 2 (first and second engine speeds) and compares the difference to one or more thresholds. In step 314, minimum and maximum threshold values may be used for the engine speed difference that occurred as a result of changing and preferably enleaning the fuel mixture provided to the engine. An engine speed difference that is below the minimum threshold (which could be a certain number of RPM's) most likely indicates that the air-to-fuel default ratio before enleanment was richer than a mixture corresponding to a peak engine power. Conversely, an engine speed difference above a maximum threshold (which could be greater than a certain number of RPM's) indicates that the air-to-fuel ratio before enleanment was leaner than a mixture corresponding to a peak engine power.

As shown in FIG. 7, for a given fixed position of the throttle valve 24 of the carburetor such as near or at the wide open throttle position, for the same amount of enleanment of the fuel mixture of the operating engine between points 400 and 402 and points 404 and 406 on the engine peak power curve 408, the difference in engine speed is greater between points 404 and 406 on the lean side of the fuel mixture from peak power output than the engine speed difference on the richer side from engine peak power output. Thus, for a given engine by selecting appropriate minimum threshold and maximum threshold speed changes 410 and 412 for the same amount of fuel enleanment, the process portion 300 can determine whether an air-to-fuel ratio of the fuel mixture is in an acceptable range or should be enleaned or enriched to achieve the desired engine operating power condition. For at least some two-cycle engines, the minimum engine speed differential threshold may be 15 RPM and the maximum engine speed differential threshold may be 500 RPM or higher. These values are illustrative and not limiting since different engines and conditions may use different thresholds.

If the engine speed difference of the speed test is within or complies with the threshold values of step 314, the process portion 300 may end at step 316 and the engine be operated throughout the rest of this period of continuous operation with the default air-to-fuel ratio because it is within an acceptable range of predetermined desired air-to-fuel ratios.

If the engine speed difference is not within the thresholds as determined at step 314, the air-to-fuel ratio may be changed at step 318 to a new air-to-fuel ratio and the engine speed tests and comparison of steps 302-314 repeated using the new air-to-fuel ratio. If the engine speed difference was less than the minimum threshold, this new air-to-fuel ratio may be further enleaned at step 318 before the engine speed test is repeated because the fuel mixture is still too rich or if this speed difference was greater than the maximum threshold, this new air-to-fuel ratio may be enriched at step 318 before the engine speed test is repeated because the mixture was too lean. The engine speed tests with changed air-to-fuel ratios can be repeated until the engine speed difference is within the thresholds of step 314. When a desired number of one or more engine speed differences complying with the thresholds of step 314 is obtained for a given changed air-to-fuel ratio, this given changed air-to-fuel ratio can be saved at step 122 of process 100 and used as the new default air-to-fuel ratio for the remainder of this period of engine continuous operation and desirably for the next engine start-up of the next period of engine operation.

As used in this description, a period of engine continuous operation is from engine start-up to the first engine stopping after this start-up. The next start-up begins a new period of engine continuous operation which ends when the engine first stops after such next start-up. Upon this next start-up, the process 100 can again be started by the operator manipulating the throttle valve 24 typically by moving the throttle lever 6.

The engine speed testing process portion 300 of FIG. 6 is disclosed in greater detail in U.S. patent application, Ser. No. 14/773,993, filed on Sep. 9, 2015, which is incorporated herein by reference in its entirety.

During the air-to-fuel ratio speed testing process portion 300 of the process, desirably, but not necessarily, the microcontroller in step 118 determines whether the speeds sensed were significantly affected by a change in the position of the throttle valve 24 and thus a change in the quantity of the air-fuel mixture supplied to the operating engine. In some implementations, the throttle valve position can be directly determined by a switch, variable resistor or other position sensing device typically connected to a throttle valve shaft or a throttle lever. However, to reduce cost, for many small engine applications, it is desirable to eliminate any such device and determine whether the throttle valve 24 position changed during the speed testing of process portion 300 by analyzing engine speed changes. It can do so at step 118 by determining whether the difference between the engine speed before enleanment (speed 1 of step 302) and the engine speed after recovery from the enleanment (a speed 3 after the engine is again operating with at least substantially and desirably the same air-to-fuel ratio used in determining speed 1) is within a specified range such as 0 to 250 RPM or not greater than 250 RPM. If the difference between speeds 1 and 3 is greater than 250 RPM the process portion 300 is aborted at step 110 and continues to use the default air-to-fuel ratio typically for the remainder of this period of continuous operation of the engine and at step 112 ends the process 100 for the remainder of this period of continuous engine operation. Typically, this throttle position change speed range difference is narrower than the speed range difference between the minimum and maximum thresholds of step 314.

However, if the engine speed difference(s) between speeds 1 and 2 was not significantly adversely affected by a change of the throttle valve position, and the process portion 300 is completed as determined at step 120, at step 122 any new and different desired air-to-fuel ratio determined by process portion 300 is saved in the memory 78 of the microcontroller as the new default air-to-fuel ratio and is used typically for the remainder of this period of engine continuous operation. It also advances to step 124 to send to the engine or string trimmer operator a signal that the engine testing and any fuel ratio adjustment process 100 is complete such as by changing the state of an indicator light in a position on the string trimmer in which it may be readily visually observed by the operator (such as in the area of the kill switch 8) or by momentarily causing the engine to stutter or rapidly change its speed such as by intermittently not sending a voltage pulse to the spark plug for several engine power strokes and/or intermittently enriching and/or preferably enleaning the ratio of the air-to-fuel mixture supplied by the carburetor to the engine by changing the state of the fuel control valve 28. Step 124 ends the process 100 at 112.

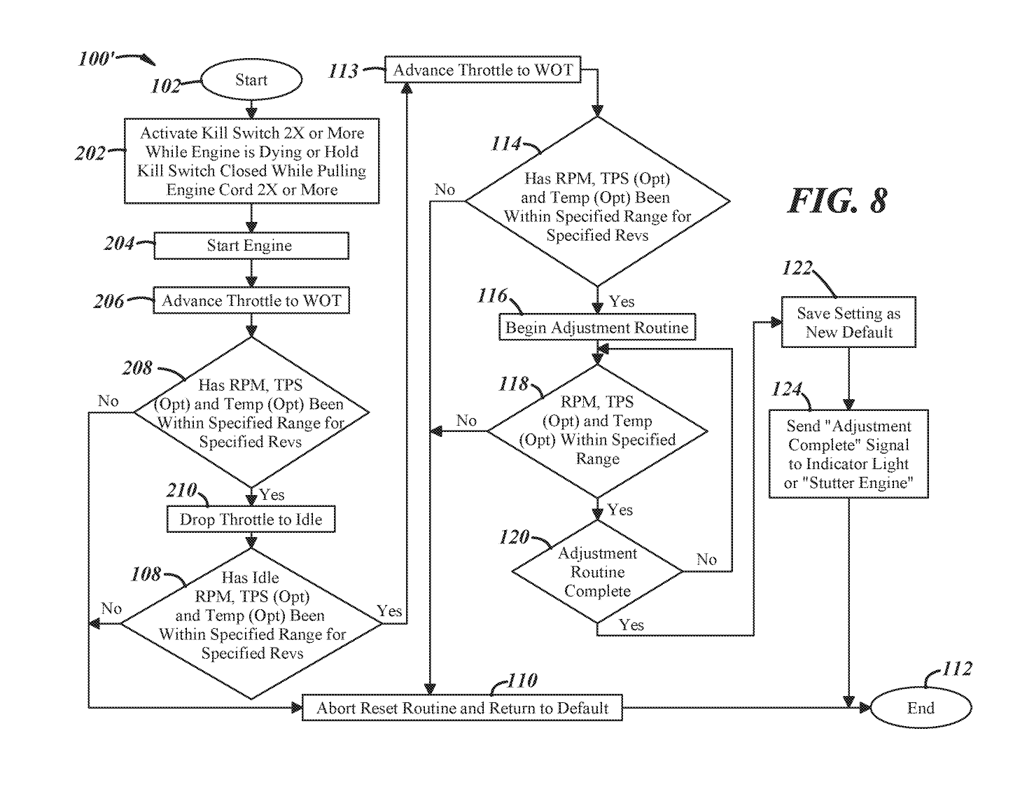

FIG. 8 shows a first modification 100′ of the way the process 100 is initiated by the operator. To the extent the steps of the modified process 100′ are essentially the same as the steps of the process 100, they have the same reference number and their description is incorporated hereat by reference and will not be repeated.

The process 100′ starts at 102 by the operator at step 202 activating the kill switch 8 a plurality of two or more times while the engine is running or dying or by holding the kill switch 8 closed while pulling the cord of the engine recoil starter a plurality of two or more times which advances to step 204 in which the engine is started by the operator and allowed to normally warm up. Any warm-up may be determined in a variety of ways such as by the microcontroller counting a specified number of engine revolutions (typically a sufficient number of revolutions for the engine to warm up from a cold start) or by sensing the engine or module temperature by circuitry including a thermistor or other temperature sensing device.

After a normal engine warm-up, the microcontroller advances to step 206 to determine whether the operator has advanced the throttle lever or valve to its substantially wide open throttle (WOT) position and, if so, advances to step 208 to determine if the engine operation is sufficiently stable which in principle is the same as step 114 in determining whether the engine speed (RPM) and optionally the throttle valve position and/or engine temperature has been within a predetermined specified range for a predetermined specified number of engine revolutions. If not, the processor proceeds to step 110 to abort the process 100 and continue to use the default air-to-fuel ratio typically for the remainder of this period of engine continuous operation and advances to 112 to end the process 100 for this period of continuous engine operation. If step 208 determines the engine is sufficiently stable, it advances to step 210 to determine whether the operator has returned the throttle lever or valve to its idle position typically for at least one-half a second and usually one to two seconds and then back to its wide open throttle position. If so, it advances to step 108 to determine if the engine is in a stable idle operating condition. If not, it goes to step 110 to abort the process. If so, it goes to step 113 to determine whether the operator has again advanced the throttle valve to its WOT position. If so, it goes to step 115. Steps 113, 114, the portion 300 of the process, and steps 116, 118, 120, 122 and 124 are the same as those steps of process 100 which are incorporated hereat by reference and will not be repeated.

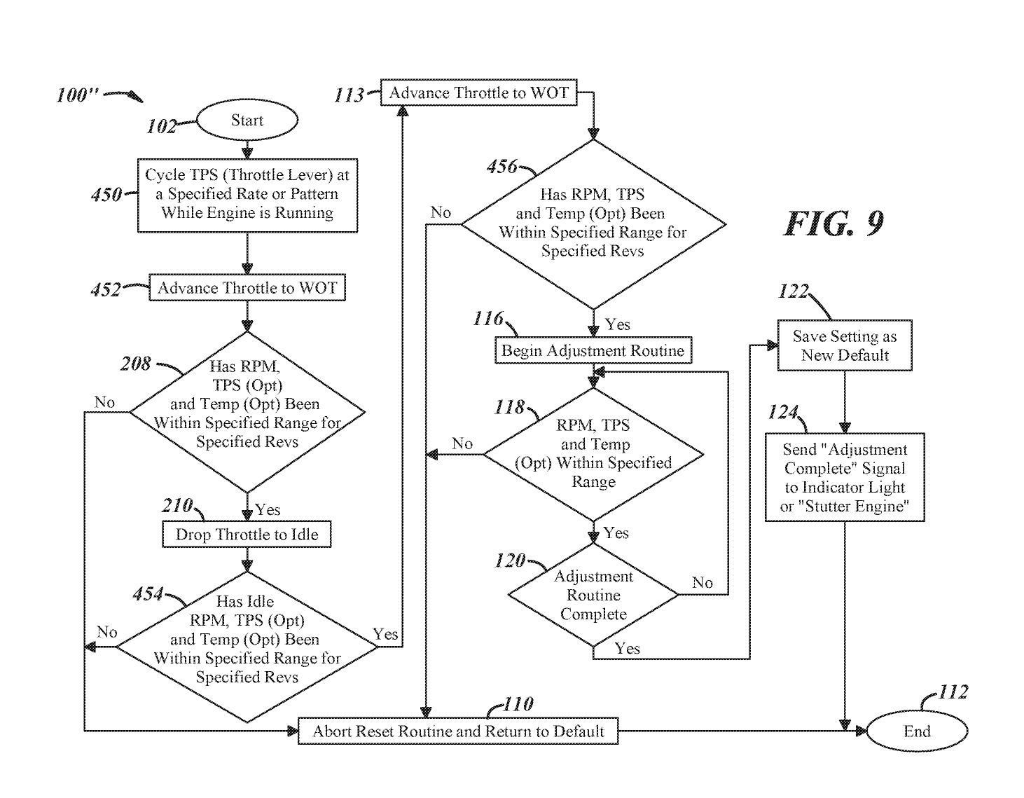

FIG. 9 illustrates another modification 100″ of the process 100 in the way in which the operator manually starts the process. To the extent the steps of process 100″ are the same as steps of the processes 100 and 100′, they have the same reference number and their description is incorporated hereat by reference and will not be repeated. While the engine is running the process 100″ is started at 102, and in step 450 the microcontroller determines whether the operator is manually cycling the throttle lever 6 and thus the throttle valve 24 at a predetermined specified rate or in a predetermined specified pattern. If the operator does so, the process advances to step 452 to determine whether the operator has manually moved or advanced the throttle lever or valve to its wide open position (WOT). If the microcontroller determines the operator has done so, it advances to step 208 to determine engine high speed stability. If step 208 determines the engine is not sufficiently stable, it goes to step 110 to abort the process 100″ and continues to use the default air-to-fuel ratio. If step 208 determines engine operation is sufficiently stable, it advances to step 210 in which the microcontroller determines whether the operator has moved the throttle lever or valve to idle. If so, it advances to step 454 to determine if the engine is operating in its idle speed range and optionally whether a sensor device such as a switch indicates the throttle valve 24 is at or within 10% of its idle position. If not, the process proceeds to the abort step 110 and ends at 112. If so, the process advances to step 113 to determine whether the operator has moved the throttle valve to its WOT position. If so, the process advances to step 456 to determine if the engine speed is in a specified range and the throttle valve is within 75% to 100% of its WOT position for a specified range of engine crankshaft revolutions. In this step 456, a device such as a switch or a variable resistor indicates whether the throttle valve 24 is at least within 75% of its WOT position. If the engine speed and/or throttle valve position are not within the specified ranges, the process goes to the abort step 110 and ends at 112. If they are in the specified ranges, the process advances to step 116. Steps 208, 210, 113, the portion 300 of the process, and steps 116, 118, 120, 122, 124 are the same as those steps of process 100′ and 100 which are incorporated hereat by reference and will not be repeated.

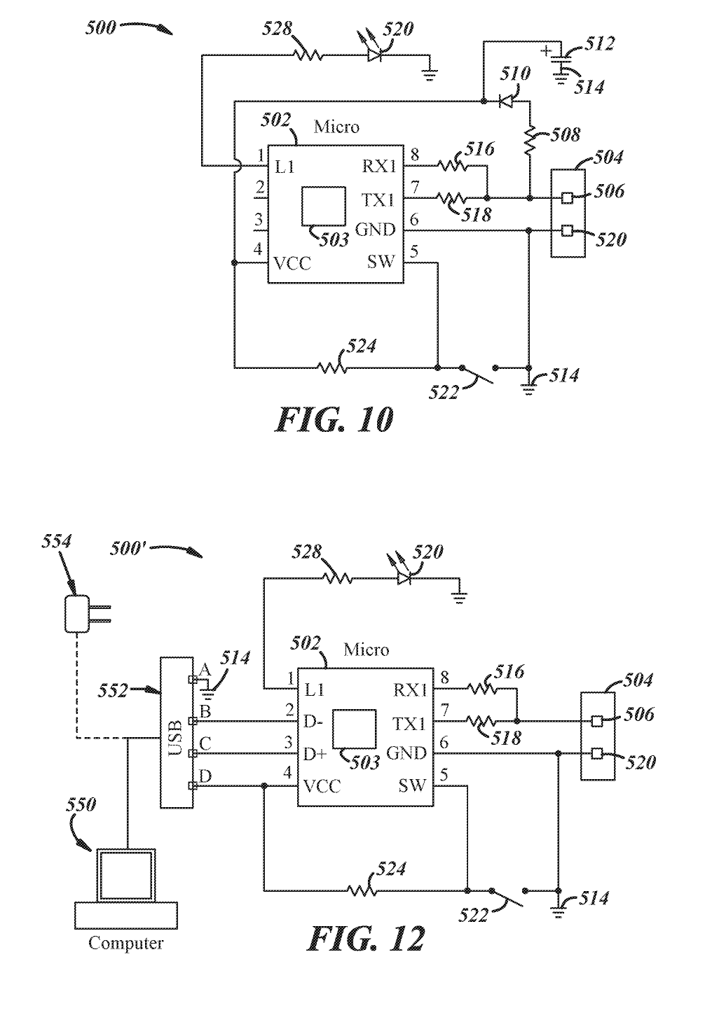

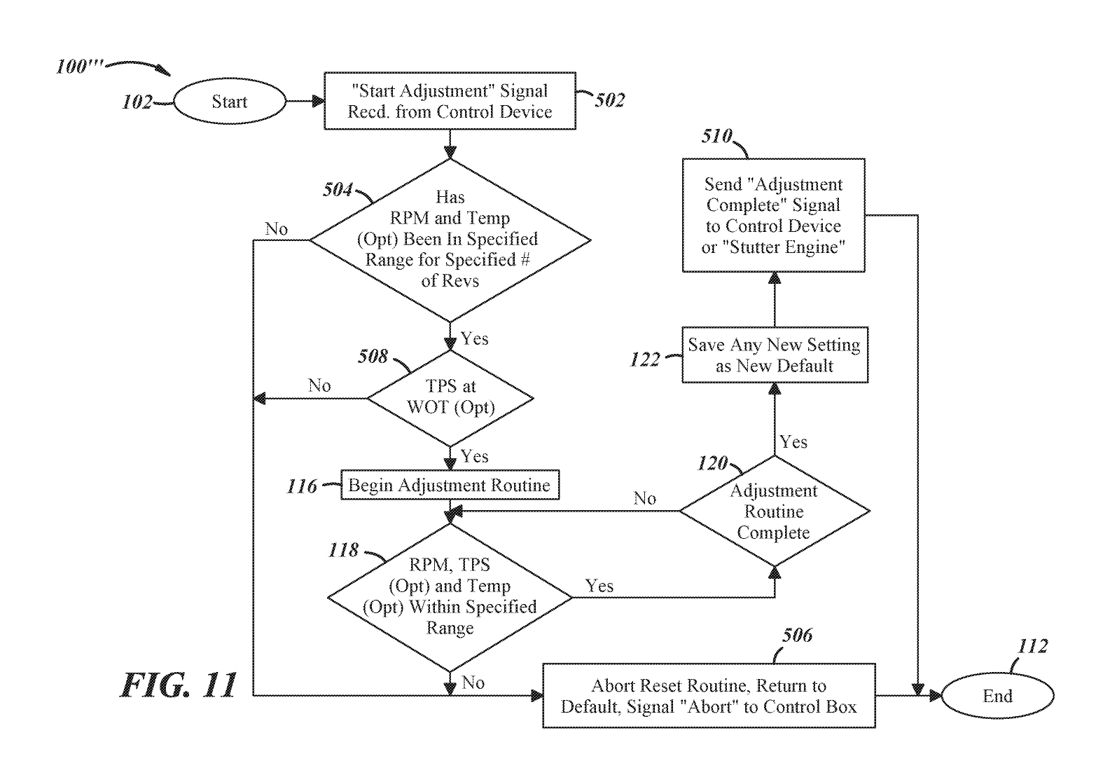

FIG. 10 illustrates an actuator circuit 500 for a separate device which the operator can connect to the control circuit 70 and use to cause its microcontroller 76 to begin and use a modified form 100′″ shown in FIG. 11 of the process 100 to test and adjust the air-to-fuel ratio of the operating engine. The actuator circuit 500 has a microprocessor 502 with 8 pins and a memory 503, and a connector 504 for connection to the control circuit 70. Power is supplied from the engine control circuit 70 to pin 4 of the microcontroller 502 from connector terminal 506 through a resistor 508 and a diode 510. Preferably to decrease circuit noise a capacitor 512 is connected to pin 4 downstream of the diode 510 and to circuit ground 514. A signal receiving pin 8 is connected through a resistor 516 to connector terminal 506 and signal transmitting pin 7 is connected through a resistor 518 to connector terminal 506. The microcontroller ground pin 6 is connected to connector ground terminal 520 and also to the circuit ground 514. To prevent closure of an operator activation switch 522 from shorting out power to the microcontroller 502, it is also connected through a resistor 524 to pin 4. To provide an operator with a visual indication of when the control circuit 70 has completed or aborted the air-to-fuel ratio test and adjustment process 100′″ a light emitting diode 526 visually observable by the operator is connected through a resistor 528 to pin 1 of the microcontroller 502.

In use of the actuator circuit 500, its connector 504 may be connected to a complementary connector of the control circuit 70 which connects its data terminal 93 to terminal 506 and its ground 82 to ground terminal 520. Alternatively, the actuator circuit terminal 506 can be connected to the terminal 512 of the control circuit and the ground terminal 520 to the control circuit ground 82. In use of the activator circuit 500 when connected to the control circuit 70, and with the engine running, the operator closes the activation switch 522 which causes the microcontroller 502 through its pin 7 to send a signal to the microcontroller 76 to start the process 100′″.

As shown in FIG. 11, the process 100′″ starts at 102 and in step 502 receives the start adjustment signal from the actuator circuit 500 and proceeds to step 504 to determine engine operating stability by sensing the engine speed (RPM) and optionally the temperature and determines whether it or they have been in a predetermined specified range for a predetermined specified number of crankshaft revolutions. If not, the process 100′″ goes to step 506 in which the process 100′″ is terminated or aborted, and an abort signal is sent to the microcontroller 502 which optionally may provide a visual indication by LED 526 that the process 100′″ has been aborted, and at 112 ends the process 100′″. If aborted, the operator may again close the actuation switch 522 to send another start adjustment signal to restart the process 100′″.

If step 504 determines that the engine speed (RPM) and optionally the temperature is within the predetermined specified range for a predetermined specified number of crankshaft revolutions, the process may optionally proceed to step 508 to determine whether the throttle valve 24 of the carburetor is in its wide open throttle position. If not, it proceeds to step 506 and at 112 ends the process 100′″. If optional step 506 determines that the throttle valve is in its wide open throttle position or if step 506 is not used, the control circuit 70 proceeds to step 116 to initiate the air-to-fuel ratio testing and adjustment portion 300 of the process. Step 116, the process portion 300, and steps 118, 120, and 122 of process 100′″ are the same as these steps of process 100 the description of which is incorporated hereat by reference and will not be repeated. At step 510, the control circuit 76 sends an adjustment complete signal to the actuator circuit 500 or stutters the engine as previously described to indicate to the operator that the testing and any adjustment of the air-to-fuel ratio has been completed. In response to the adjustment complete signal, the microcontroller 502 of the actuator circuit 500 may provide power to its LED 526 to provide a visual indication to the operator that process 100′″ has been completed. Step 510 will also end at 112 the process 100′″ for the remainder of the period of engine continuous operation.

FIG. 12 illustrates a modification 500′ of the actuator circuit 500 (FIG. 10) which can be connected to a personal computer 550 to obtain data from the microcontroller 502 and its memory 503 or to transmit data to them such as for changing or modifying the program of the microcontroller 502 and/or its memory 503. As shown in FIG. 12, a USB port 552 has a first terminal A connected to ground 514, a second terminal B connected to pin 2 of the microcontroller 502 for the purpose of receiving data and a third terminal C connected to pin 3 of this microcontroller for the purpose of transmitting data. A fourth terminal D is connected to pin 4 of microcontroller 502 to supply power to this microcontroller from the computer 550. Alternatively, to use the actuator circuit 500′ for the process 100′″, it can be powered by an external DC power supply device 554 (such as a 110-120 volt AC to 5 volt DC adaptor or a battery pack) with a USB or other suitable connector plug compatible with the USB port 552.

In a single engine running or operating period, the operator typically starts the process 100, 100′, 100″ or 100′″ only once and even in a long running period such as 45 to 120 minutes with changing conditions no more than 3 to 5 times. Thus, during a single operating period, the process is carried out only intermittently and usually only when an operator believes the engine is operating poorly. In many instances, the engine will be run for several to many operating periods before the operator starts the process.

In at least some implementations of the process 100, 100′, 100″, and 100′″ for a single cylinder two-cycle engine, the time limit of step 104 may be in the range of 5,000 to 12,000 RPM for a total of 500 to 25,000 crankshaft revolutions, in step 108 the idle engine speed may be in the range of 1,500 to 4,000 RPM for at least 400 crankshaft revolutions, in step 114 the engine speed may be in the range of 6,000 to 10,000 RPM for at least 400 engine crankshaft revolutions, in step 118 the acceptable difference between engine speed 1 and speed 3 may be in the range of 0 to 250 RPM, desirably 40 to 100 RPM and preferably 60 to 80 RPM, and in step 314, the minimum threshold engine speed difference may be in the range of 10 to 100 RPM, and the maximum threshold engine speed difference may be in the range of 100 to 500 RPM and desirably in the range of 100 to 300 RPM. In the modified process 100′ and 100″, in step 208 the engine speed may be in the range of 5000 to 12,000 RPM for at least 400 crankshaft revolutions, and in step 210 the throttle valve may be in its idle position for at least ½ second and desirably one to two seconds. In the modified process 100″ in step 454 the idle engine speed may be in the range of 1,500 to 4,000 RPM and the throttle valve within 10% of its idle position, and in step 456 the engine speed may be in the range of 6,000 to 10,000 RPM and the throttle valve in the range of 75% to 100% of its WOT position for at least 400 crankshaft revolutions. In modified process 100′″, in step 504 the engine speed may be in the range of 6,000 to 10,000 RPM for at least 400 crankshaft revolutions and in optional step 508 the throttle valve may be in the range of 75% to 100% of its WOT position.

In at least some implementations of the process 100, 100′, 100″ and 100′″ for a single cylinder four-cycle engine, the time limit of step 104 may be in the range of 5,000 to 10,000 RPM for a total of 1,000 to 50,000 crankshaft revolutions, in step 108 the engine idle speed may be in the range of 1,500 to 4,000 RPM for at least 400 crankshaft revolutions, in step 114 the engine speed may be in the range of 6,000 to 10,000 RPM for at least 400 engine crankshaft revolutions, in step 118 an acceptable difference between engine speed 1 and speed 3 may be in the range of 0 to 250 RPM, desirably 40 to 100 RPM and preferably 60 to 80 RPM, and in step 314, the minimum threshold engine speed difference may be in the range of 10 to 100 RPM, and the maximum threshold speed difference may be in the range of 100 to 600 RPM and desirably in the range of 100 to 400 RPM. In the modified process 100′ and 100″, in step 208 the engine speed may be in the range of 5000 to 10,000 RPM for at least 400 crankshaft revolutions, and in step 210 the throttle valve may be in its idle position for at least ½ second and desirably one to two seconds. In the modified process 100″, in step 454 the idle engine speed may be in the range of 1,500 to 4,000 RPM and the throttle valve within 10% of its idle position, and in step 456 the engine speed may be in the range of 6,000 to 10,000 RPM and the throttle valve in the range of 75% to 100% of its WOT position for at least 400 crankshaft revolutions. In modified process 100′″, in step 504 the engine speed may be in the range of 6,000 to 10,000 RPM for at least 400 crankshaft revolutions and in optional step 508 the throttle valve may be in the range of 75% to 100% of its WOT position.

In at least some implementations, if initiated by the operator, the process decreases the risk of an incorrect adjustment of the air-to-fuel ratio due to unstable and/or unforeseen engine operating conditions by selecting and monitoring engine operating conditions in which engine operation is sufficiently stable to enable a successful testing and if need be changing of the air-to-fuel ratio of the operating engine. This process also provides a faster testing and any needed adjustment of air-to-fuel ratio because the engine will be operating under known stable engine operating conditions throughout the testing and any adjustment by process portion 300 and after process portion 300 is completed or aborted, desirably the air-to-fuel ratio will not be further adjusted or changed for the remainder of the period of operation of the engine. This process also reduces the complexity of programming the portion 300 of the process and decreases the required microcontroller memory because it is initiated only if the operator does so and is carried out only if the engine is operating in a stable condition.

While the forms of the invention herein disclosed constitute presently preferred embodiments, many others are possible. It is not intended to mention all the possible equivalent forms, modifications or ramifications of the invention. It is understood that the terms used herein are merely descriptive, rather than limiting, and that various changes may be made without departing from the spirit or scope of the invention.

1. A control process for an engine with a device supplying a combustible air-fuel mixture to the operating engine and having a throttle valve movable between idle and wide open throttle positions to control the quantity of the air-fuel mixture supplied to the engine, the process comprising:
an operator initiating an engine test;
the engine test comprising at least one sensing of the engine speed for a predetermined specified number of engine revolutions, determining whether the at least one sensed engine speed is within a predetermined specified range and, if not, continuing to use a default air-to-fuel ratio of a mixture supplied to the engine for substantially the remainder of the period of engine continuous operation, or, if the engine speed is within the specified range for the specified number of engine revolutions, testing the air-to-fuel ratio to determine whether it should be changed and, if not, continuing to use the default air-to-fuel ratio for the remainder of the period of engine continuous operation or, if so, determining a desired new air-to-fuel ratio and using the new air-to-fuel ratio for the remainder of the period of continuous engine operation;
during the testing of the air-to-fuel ratio determining whether a difference in a change of engine speeds is within a predetermined specified range and, if not, terminating the process of testing and any adjustment of the air-to-fuel ratio and continuing to use the default air-to-fuel ratio for operation of the engine during the remainder of the period of engine continuous operation unless a new engine test is initiated by the operator.

2. The process of claim 1 further comprising providing an indication to the operator that the testing of the air-to-fuel ratio is complete or has been terminated.

3. The process of claim 1 further comprising determining whether the operator has initiated the engine test by determining whether the throttle valve has moved to its idle position, thereafter making a second determination of whether engine speed is in a predetermined specified range for a specified number of engine revolutions, and thereafter determining whether the throttle valve has moved back to its wide open throttle position to initiate the engine test.

4. The process of claim 1 further comprising activating an engine kill switch at least two times, allowing the engine to warm up, thereafter determining whether the throttle valve has been moved to its wide open throttle position, determining whether the engine speed is within a predetermined specified range for a predetermine specified number of engine revolutions, thereafter determining whether the throttle valve has been moved to its idle position for at least 0.5 seconds and then back to its wide open throttle position to initiate the engine test.

5. The process of claim 1 further comprising to initiate the engine test determining whether the throttle valve has been cycled at a predetermined specified rate or in a predetermined specified pattern, thereafter determining whether the throttle valve has moved to its wide open throttle position, thereafter determining whether the engine speed is within a predetermined specified range for a predetermined specified number of revolutions, and thereafter moving the throttle valve to its idle position for at least two seconds and then back to its wide open throttle position to begin the engine test.

6. The process of claim 1 further comprising connecting an electronic actuator circuit having a microcontroller and an activation switch to an engine control circuit having a microcontroller, the operator changing the state of the actuation switch to cause the actuator microcontroller to send a signal to the engine microcontroller to initiate the engine test.

7. The process of claim 1 wherein the operator initiates the engine test cycle not more than five times during the period of engine continuous operation.

8. The process of claim 1 wherein the operator initiates the engine test not more than one time during the period of engine continuous operation.

9. The process of claim 6 further comprising the actuator circuit including a USB port connected to the actuator circuit microcontroller, and an operator connecting a personal computer to the USB port to receive data from the actuator circuit microcontroller to the personal computer or an operator using the personal computer to transmit data to the actuator circuit microcontroller.

10. The process of claim 6 further comprising the actuator circuit including a USB port connected to the actuator circuit microcontroller, and an external power supply connected to the actuator circuit microcontroller.

11. The process of claim 1 further comprising determining whether the difference in engine speeds before and after the engine test is greater than a threshold engine speed and if so continuing to use the default air-to-fuel ratio for operation of the engine.

12. The process of claim 11 wherein the threshold engine speed is 250 RPM.
